(19) United States
(12) Patent Application Publication
(10) Pub. No.: US 2014/0377411 A1
(43) Pub. Date: Dec. 25, 2014

(54) Beverage Coffee Product with Vitamins and Minerals Added

(71) Applicant: David Hadasz, Marcy, NY (US)

(72) Inventor: David Hadasz, Marcy, NY (US)

(21) Appl. No.: 13/922,347

(22) Filed: Jun. 20, 2013

(51) Int. Cl. A23F 5/14

(52) U.S. Cl. CPC A23F 5/14
USPC 426/72

(57) ABSTRACT

A beverage product with nutrients added is comprised of ground roasted coffee beans and a dry mixture of additional nutrients blended with the ground roasted coffee. The dry mixture includes at least water soluble vitamins in effective amounts, e.g., B and C vitamins, and water soluble essential minerals in effective amounts. The B vitamins may include Thiamin, Riboflavin, Niacin, Pantothenic Acid, Pyridoxine, Biotin, Folate, and one of Methylcobalamin and Cyanocobalamin. The essential minerals may include Iron, Calcium, Copper, Chromium, Choline, Inositol, Iodine, Magnesium, PABA, Phosphorus, Potassium, Selenium, Sodium and Zinc

Applicant claims priority under 35 U.S.C. 119(e) of provisional application Ser. No. 61/664,436, filed Jun. 26, 2012, the contents of which are incorporated herein by reference.

### BACKGROUND OF THE INVENTION

A cup of coffee can be an essential part of the morning routine of many individuals. Many persons skip breakfast or otherwise fail to observe a diet that contains the vitamins and minerals needed for optimum health. It is desired to provide such persons with a coffee option that promotes a healthy life. The concept for the coffee product with water-soluble vitamins and essential minerals added, which we have termed “Good Life Coffee” is derived from the concept that coffee can taste good, and can all the while be healthy and nutritionally beneficial to its drinkers. The Good Life Coffee product is true Vitamin Coffee. Each serving is vitamin infused upon brewing. Other coffee supplemental products only offer instant coffee or flavor options, or they promote nutrient packets added to the coffee after brewing.

Each container of Good Life coffee is fortified with rich sources of water-soluble (iconic) vitamins and minerals. Foods that contain iconic nutrients facilitate optimal health as well as regulate important cellular functions. These include metabolism, immune system regulation, and heart function. These compounds are easily digested and excreted by the body when there is excess, therefore providing zero or near zero risk of toxicity. In turn, because these vitamins are not stored, they must be replenished on a daily basis. The key ingredient in coffee is caffeine. As a natural diuretic, caffeine can deplete the body of Vitamin B-complex, Vitamin C, essential minerals, nutrients, and anti-oxidants. Since coffee drinking is part of the daily routine of many individuals, Good Life Coffee ensures replenishment of these essential nutrients.

### SUMMARY OF THE INVENTION

Good Life Coffee provides the freshest grades of regular, extra bold, and decaffeinated domestic coffee (and herbal teas in some embodiments). The coffee is ground to the fineness needed for the coffee drinkers brewing system, i.e., between very fine and coarse. Coffee beans will be procured from domestic sources. The beans will be roasted and ground. Then the ground coffee is fortified with vitamins and minerals in a powder compound, and the coffee is pre-packaged in containers or bags. The coffee drinker brews this in a coffee system just as normal, e.g., drip filter coffee machine. The vitamins and minerals are already in the brewed coffee as soon as the coffee is brewed, and do not need to be added to the brewed coffee product.

The roasting of the coffee beans is carried out before the vitamins and essential minerals and other food supplements are present, and the food supplements are added before the product is sealed into a bag or canister, so there is no degradation of these components from the heat of roasting or from storage prior to brewing the coffee beverage.

### Product Composition & Benefits:

The following are nutrients contained in Good Life Coffee, with their health benefits:

### Vitamins

Vitamin C—is a powerful antioxidant. Vitamin C builds collagen and other connective tissue; aids in wound healing, and bone and tooth formation; strengthens blood vessel walls; promotes absorption of iron, calcium, and folacin; facilitates the production of brain hormones; and is vital to immune system function. It is also essential in preventing nutritional ailments and disease, including scurvy.

### Vitamin B Complex

B1 (Thiamin)—is often referred to as the “morale vitamin” due to its positive effects on the nervous system and mental outlook. Thiamine can have potential benefits that include improved digestion, appetite regulation, reduced fatigue, and moist mucous membranes.

B2 (Riboflavin)—is an antioxidant, improving the release of energy from food, normal growth and development, and vision. Proper amounts of riboflavin increase the healthy look of skin, nails, and hair.

B3 (Niacin)—is very important for maintaining a healthy heart, healthy blood lipids, nervous system function, and appetite control.

B5 (Pantothenic Acid)—aids in hormone production, adrenal function, and the Krebs cycle.

It may also assist with improvement of acne, performance enhancement of athletes, and alleviation of lupus symptoms.

B6 (Pyridoxine)—is essential for more than 100 different enzymatic reactions. It is helpful in lipid metabolism, nervous system function, protein digestion and absorption, red blood cell formation, and neurotransmitter syntheses. Vitamin B6 is an active participant in the chemical reactions of amino acids, helps maintain normal functioning of the brain, and promotes the formation of red blood cells.

B7 (Biotin)—is a catalyst for various metabolic reactions including regulation of blood sugar, glucose processing to release energy stores, proper heart functioning, cholesterol reduction, synthesis of fatty acids and amino acids, repairing muscle tissue, maintaining good health of human skin and hair, and proper functioning of nervous system tissues, along with desired growth of bone marrow. The lack of Vitamin B7 may lead to fatigue, depression, muscular pain, hair loss, and anemia.

B9 (Folate/Folic Acid)—is necessary for maturing red and white blood cells and also for DNA synthesis.

B12 (Methylcobalamin/Cyanocobalamin)—aides in building genetic materials, production of red blood cells, and DNA syntheses. Lack of Vitamin B12 can lead to psychological symptoms, fatigue, weakness, weight loss, and pernicious anemia, causing irreversible nerve damage.

### Other Nutrients

Dietary Fiber—aids in digestion and weigh loss. Fiber also decreases the risk of diabetes and heart disease, lowers cholesterol, stabilizes blood sugar levels, and prevents and/or relieves constipation.

Protein—breaks down into amino acids, which are necessary for building muscle and blood. Protein is essential for maintaining healthy muscles, tissue and muscle repair, immune system function, illness and disease prevention, and energy production. Protein also helps build skin, hair, nails, and cartilage.

### Essential Minerals

Iron—is a trace mineral that forms part of hemoglobin, the pigment that gives blood its dark red color. Iron binds and transports oxygen to the cells, and is essential to brain development and growth, preventing learning disabilities in children, regulation of body temperature, maintaining restful sleep patterns, immune system function, and increased muscle activity and metabolism. It also boosts the body's energy levels.

Calcium—is vital for strong bones, teeth, and gums. Calcium lowers cholesterol and helps prevent cardiovascular disease. Women often need a little more calcium than is included in a balanced formula.

Copper—aids in formation of bone, hemoglobin, and red blood cells, and works in balance with zinc and Vitamin C to form elastin, a skin protein. It is important for healthy nerves and joints, healing, energy, taste sensitivity, and hair and skin coloring.

Chromium—is essential for maintaining stable blood sugar levels, weight management, and controlling of diabetes.

Choline—is necessary for nervous system function, gallbladder regulation, liver function, hormone production, proper brain function, and memory.

Inositol—Inositol is used for diabetic nerve pain, panic disorder, high cholesterol, insomnia, cancer, depression, schizophrenia, Alzheimer's disease, attention deficit-hyperactivity disorder (ADHD), autism, promoting hair growth, psoriasis, and treating side effects of medical treatment with lithium.

Iodine—helps to metabolize excess fat, and necessary for thyroid function. It is also important for physical and mental development.

Magnesium—promotes nerve and muscle transmission; helps prevent depression, dizziness, muscle weakness, and PMS; acts as a catalyst in enzyme activity especially energy production; and aides in calcium and potassium uptake.

PABA (Para-aminobenzoic-acid)—is important for maintaining healthy skin, hair pigmentation and growth, formation of red blood cells, Vitamin B5 synthesis, prevention of fibrous tissue, metabolism and utilization of protein, and intestinal function.

Phosphorus—is necessary for blood clotting, bone and tooth formation, cell growth, contraction of the heart muscle, normal heart rhythm, and kidney function

Potassium—is essential to maintaining a healthy nervous system and regular heart rhythm. Protein helps prevent stroke, aids in proper muscle contraction, and works with sodium to control the body's water balance.

Selenium—is a vital antioxidant, which inhibits the oxidation of lipids, and prevents the formation of free radicals.

Sodium—is necessary for maintaining proper water balance and blood pH; and stomach, nerve, and muscle function.

Zinc—is essential for prostate gland function and growth of the reproductive organs.

Serving size is approximately a six to eight-ounce cup of the brewed coffee. A pound of the ground coffee will yield typically 30 to 35 servings, depending on the coffee grind. Usually there are about eight cups per pot and four pots per pound of ground roasted coffee.

The nutritive value of the brewed coffee product is substantially as follows:

| | Amount | | Amount | | % Daily |
|---|---|---|---|---|---|
| Nutrient | Per pound | | Per Cup | | Value |
| Calories | 120 | calories | 3.75 | calories | negligible |
| Total Carbohydrate | 13 | grams | 0.41 | grams^{†} | 4% |
| Dietary Fiber | 6 | grams | 0.19 | grams^{†} | 24% |
| Protein | 16 | grams | 0.50 | grams | negligible |
| Thiamin (vitamin B-1) | 1.36 | mg | 0.04 | mg | 91% |
| Riboflavin (vitamin B-2) | 1.05 | mg | 0.03 | mg | 62% |
| Niacin | 10 | mg | 0.31 | mg | 50% |
| Vitamin B-6 | 1.2 | mg | 0.04 | mg | 60% |
| Folic Acid | 200 | μg | 6.25 | μg | 50% |
| Vitamin B-12 | 0.1 | μg | 0.003 | μg | 2% |
| Biotin | 15 | μg | 0.47 | μg | 5% |
| Pantothenic Acid | 0.5 | mg | 0.02 | mg | 5% |
| Iron | 5.4 | mg | 0.17 | mg | 30% |
| Phosphorus | 800 | mg | 25.00 | mg | 80% |
| Magnesium | 20 | mg | 0.63 | mg | 5% |
| Zinc | 3 | mg | 0.09 | mg | 20% |
| Selenium | 63 | mcg | 1.97 | mcg | 90% |
| Copper | 0.1 | mg | 0.00 | mg | 5% |
| Chromium | 168 | mcg | 5.25 | mcg | 140% |
| Sodium | 70 | mg | 2.19 | mg^{†} | 3% |
| Potassium | 600 | mg | 18.75 | mg | 17% |
| RNA/DNA | 2 | grams | 0.06 | grams | not est. |
| Choline | 125 | mg | 3.91 | mg | not est. |
| Inositol | 100 | mg | 3.13 | mg | not est. |
| PABA | 0.75 | mg | 0.02 | mg | not est. |

(para-aminobenzoic acid)

^{†}Percent Daily Values are based on a 2,000 calorie diet.
* (not est. = Daily Value not established).

In the preferred embodiment as discussed above, a regular ground coffee is used as a base, and the vitamins and minerals are added in the amounts as listed. However, the amounts may vary somewhat and still be in a suitable range of effectiveness. Other items may be added as well, e.g., flavorants and fillers such as a hazelnut extract or chicory. This formulation may also be used with decaffeinated coffee, or with tea leave to achieve proper intake of vitamins and minerals for those who prefer a morning coffee. The vitamin and mineral additives do not affect the taste of the coffee, tea, or other beverage.

The following is a list of the vitamins and minerals per serving of the brewed coffee according to one preferred blend, the blend being based on fully roasted and ground Arabica beans, giving the amount plus the percent daily requirement or each: Vitamin C (ascorbic acid) 1 g, 1,667%; Thiamin (Vitamin B-1) 1.35 mg, 91%; Riboflavin (Vitamin B-2) 1.05 mg, 62%; Niacin, 10 mg, 50%; Vitamin B-6, 1.2 mg, 60%; Folic Acid, 200 mcg, 50%; Vitamin B-12, 0.1 mcg, 2%; Biotin, 15 mcg, 5%; Pantothenic Acid, 0.5 mg, 5%; Iron, 5.4 mg, 30%; Phosphorus, 800 mg, 80%; Magnesium, 20 mg, 5%; Zinc, 3 mg, 20%; Selenium, 53 mcg, 90%; Potassium, 800 mg, 3%;RNA/DNA, 2 g, (percent not determined); Chlorine, 125 mg (percent not determined); Inositol, 100 mg (percent not determined); PABA (para-aminobenzoic acid) 0.75 mg (percent not determined). Available copper and chromium are also present.

Many other variations will present themselves to those skilled in this art without departing from the spirit of this invention.

What is claimed is:

1. A beverage product with nutrients added, of the type described, comprising
a quantity of ground roasted coffee beans; and
a dry mixture of additional nutrients, blended with said ground roasted coffee, that includes at least water soluble vitamins in effective amounts to include a plurality of B vitamins and C vitamin, and a plurality of water soluble essential minerals in effective amounts.

2. The beverage product of claim 1, wherein said B vitamins include at least Thiamin, Riboflavin, Niacin, Pantothenic Acid, Pyridoxine, Biotin, Folate, and one of Methylcobalamin and Cyanocobalamin.

3. The beverage product of claim 1, wherein said essential minerals include at least Iron, Calcium, Copper, Chromium, Choline, Inositol, Iodine, Magnesium, PABA, Phosphorus, Potassium, Selenium, Sodium and Zinc.

4. The beverage product of claim 1, wherein the additional nutrients are blended with the ground roast coffee in amounts per quantity of the ground roast coffee substantially as specified in the chart found in the specification hereof.

5. The beverage product of claim 1, wherein the dry mixture of additional nutrients is added after the coffee beans have been roasted and ground, and before the resulting product has been packaged and sealed.

6. The beverage product of claim 1, wherein the dry mixture of additional nutrients includes sufficient C vitamin to provide substantially 1,667 percent minimum daily requirement thereof per serving of the beverage product after it has been brewed.
